(19) United States
(12) Patent Application Publication
(10) Pub. No.: US 2010/0040261 A1
(43) Pub. Date: Feb. 18, 2010

(54) BIOMETRIC IDENTIFICATION ASSURANCE METHOD AND TOKEN RETRIEVAL

(75) Inventor: Craig McMillan, Regina (CA)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/190,248

(22) Filed: Aug. 12, 2008

(51) Int. Cl. G06K 9/00

(52) U.S. Cl. 382/115

(57) ABSTRACT

The present disclosure is directed to a method for securing access to a system. The method may comprise collecting a set of biometric information and a set of personal information of a person; storing the set of biometric and personal information to a certifying device; receiving a first biometric input from the person; sending the first biometric input to the certifying device; receiving a set of requested biometric tests from the certifying device, the set of requested biometric tests is randomly selected from the set of biometric information; collecting a set of biometric inputs from the person in response to the set of requested biometric tests; sending the set of biometric inputs to the certifying device; determining whether the biometric inputs are valid; receiving a token with personal information representing the person when the biometric inputs are valid; registering the token with the system to allow access to the system.

### TECHNICAL FIELD

The present disclosure generally relates to the field of security, and more particularly to a biometric identification assurance method.

### BACKGROUND

Biometric signatures are considered to be very accurate when authenticating an individual. However, biometric signature readers and/or detectors may be compromised. For example, the use of biometric input devices may lead to techniques to defeat the scanning technology. Multiple inputs may be utilized to increase the security of the authentication system, however, if the inputs and order of input are known in advance, strategies to defeat the system may still be developed.

### SUMMARY

The present disclosure is directed to a method for securing access to a system. The method may comprise collecting a set of biometric information and a set of personal information of a person; storing the set of biometric information and the set of personal information to a certifying device; receiving a first biometric input from the person; sending the first biometric input to the certifying device; receiving a set of requested biometric tests from the certifying device, wherein the set of requested biometric tests is randomly selected from the set of biometric information of the person; collecting a set of biometric inputs from the person in response to the set of requested biometric tests; sending the set of biometric inputs to the certifying device; determining whether the first biometric input and the set of biometric inputs are valid; receiving a token with personal information representing the person when the first biometric input and the set of biometric inputs are valid; registering the token with the system to allow access to the system.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for securing access to a system.

### DETAILED DESCRIPTION

Reference will now be made in detail to the subject matter disclosed, which is illustrated in the accompanying drawings.

The present disclosure is directed to provide a portable authentication method to allow the incorporation of bearer information into an environment without the need to manually enter data into an interface to the system being accessed. This authentication method may also defeat attempts to bypass or provide spurious biometric credentials.

Utilizing the authentication method, a person attempting to obtain access to a system is required to present biometric credentials following a set of guidelines unknown to the person at the time of presentment. The set of guidelines may comprise a randomly generated number of biometric tests to ensure that only valid credentials are being provided. Such authentication method may not be compromised unless all aspects of the person attempting to obtain access to the system are replicated and information held by a certifying device is corrupted.

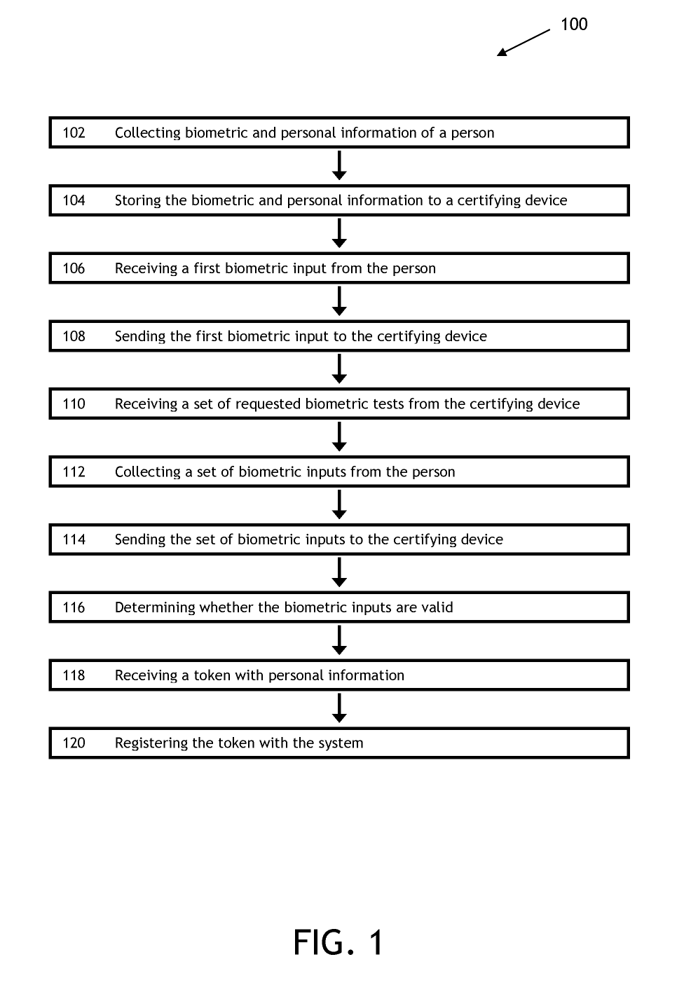

FIG. 1 shows a flow diagram illustrating steps performed by an authentication method 100 in accordance with the present disclosure. Step 102 collects a set of biometric information and a set of personal information of a person. The set of biometric information collected in step 102 may comprise a number of possible biometric identifiers. Such identifiers may include, for example, scans of all fingers, irises, face recognition measurements, typing patterns, voice, among others. The set of personal information collected in step 102 may comprise information such as name, address, phone number, as well as other types of information about the person. Step 104 stores both the set of biometric information and the set of personal information about the person to a certifying device.

When attempting to obtain access to a system, the person is required to provide a first biometric input to the system in step 106. The system being accessed then sends the first biometric input to the certifying device in step 108. In step 110 the certifying device provides the system a set of randomly generated number of requested biometric tests. The set of requested biometric tests are randomly selected from the set of biometric information collected in step 102. It is understood that the set of requested biometric tests may be different on each attempt. For example, in the first attempt, the set of requested biometric tests may include four tests comprising: left iris, third finger of left hand, signature, and second finger of left hand; in the second attempt, the set of requested biometric tests may include five tests comprising: left iris, first finger of left hand, voice, right iris, and fourth finger of right hand.

Step 112 collects a set of biometric inputs from the person in response to the set of requested biometric tests. The set of biometric inputs is sent to the certifying device in step 114. Step 116 determines whether all biometric inputs (the first biometric input received in step 106 and the set of biometric inputs collected in step 112) provided by the person may prove to be valid. If valid, the system receives a token with personal information of the person attempting access in step 118. The token works like a business card, which is registered with the system in step 120 indicating that the person is valid within the system and allows for access to the system. The system may refuse access if not all biometric inputs are valid.

It is contemplated that login information and/or credential may be required in addition to verification of biometric information to further strengthen the security of the method. It is understood that random testing of biometric information may ensure that tokens continue to be valid. It is also understood that to maximize security of the method, a complete validation mechanism verifying against the entire set of biometric information collected may be invoked.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for securing access to a system, comprising:
collecting a set of biometric information and a set of personal information of a person;
storing the set of biometric information and the set of personal information to a certifying device;
receiving a first biometric input from the person;
sending the first biometric input to the certifying device;
receiving a set of requested biometric tests from the certifying device, wherein the set of requested biometric tests is randomly selected from the set of biometric information of the person;
collecting a set of biometric inputs from the person in response to the set of requested biometric tests;
sending the set of biometric inputs to the certifying device;
receiving a login credential;
determining whether the first biometric input, the login credential, and the set of biometric inputs are valid;
receiving a token with personal information representing the person when the first biometric input, the login credential, and the set of biometric inputs are valid;
registering the token with the system to allow a one-time access to the system.
